(19) United States
(12) Patent Application Publication
(10) Pub. No.: US 2004/0117782 A1
(43) Pub. Date: Jun. 17, 2004

(54) Construction method of external links for software execution environment

(76) Inventor: Tse-Win Lo, Taipei (TW)

Correspondence Address: TROXELL LAW OFFICE PLLC, SUITE 1404, 5205 LEESBURG PIKE, FALLS CHURCH, VA, 22041, US

(21) Appl. No.: 10/319,481

(22) Filed: Dec. 16, 2002

(51) Int. Cl. G06F 9/44; G06F 9/445

(52) U.S. Cl. 717/165; 717/116; 717/174

(57) ABSTRACT

A construction method of external links for software execution environment, being a specific software structure which especially focuses on the redefinition to the linkage between Objects for supporting the functions of the Objects, such as Enforce Output, Enforce Input, Excite, etc. The functions of the method can avoid the inconvenience to software designers; in addition, reduce software development costs and promoting the flexibility of software maintenance.

### BACKGROUND OF THE INVENTION

1. Field of Invention

The present invention relates to a construction method of external links for software execution environment, specifically, the invention proposes a software structure, which quickly generates the program results through specific software execution environment. The invention is particularly applicable to some chips and/or programming languages with specific instructions, operating systems with specific services, or some library with specific functions.

2. Description of Prior Art

With the development of various industries, people's dependence on computer is on the increase, so is the demand for software. Nowadays, both software volumes and functions are much in demand; in other words, software programmers have to develop much more complex software to meet the requirements of their clients.

Software construction in the past mainly can be divided into two methods; one is Process Oriented, and the other Object Oriented. The Process Oriented Method separates Data from Procedure, and uses the Procedure as the main body to process data, or to exchange data between Procedures by parameters or returned values. The currently used Object Oriented Method is an advanced way of implementing the Process Oriented Method. It combines some procedures (called Member Function) with some data (called Member Variable) into a Class. In the execution time, we make an Instance to operate the data. Therefore, linking some Member Variables with Member Functions can avoid some redundant data translation between Member Functions.

Actually, the software constructions of these two methods are the same. However, by the restriction of CPU structure and Programming Language structure, we have to use Function Invocation to execute another procedure, by the Nested Structure, which causes the following two problems:

1. Coding Time Recognizing: During the Coding Time, a programmer has to understand the properties of the Function Invocation Target, such as Function Name, Parameters, or Class Definition. After the software is finished, no matter what function should be amended, all other parts of the software that use this Function have to be changed. This problem makes the high cost of software maintenance.

2. Nested Structure: Basically, it is a kind of big structure that entirely contains some smaller structures. Seeing that software of the present time is very huge, there are usually thousands layers of Nested Structure; therefore, when any part of the software needs to be maintained, we have to decompose all the layers as required. It usually causes over damage of maintenance.

In view of the foregoing, a software structure model of the invention is disclosed herein. It can lower the cost of software development and the complexity of software maintenance.

### SUMMARY OF THE INVENTION

In view of the aforementioned known problems, the invention aims at proposing an construction method of external links for software execution environment, which utilizes the linking relationship between Objects that are defined by users for accelerating the generation of programs. Therefore, the main object of the invention is to solve the said problems: first, Coding Time Recognizing: During Coding Time, an Object is only required to link its own Member Functions to enable the communication with other Objects by Execution Environment; second, Nested Structure: many Nested Structures were generated by the linkage requirements in the past. Therefore, this method of the invention is able to reduce Nested Structures by the purpose of linkage to lower software development cost and promote the flexibility of software maintenance.

For achieving the aforementioned objects, the method of the invention further comprises the following Steps: a. defining a software execution environment; b. installing at least one Object through the software execution environment; c. controlling the linkage of at least one Object Member Functions through the software execution environment; d. constructing programs by the Object and the linkage thereof.

To enable a further understanding of the objective, structural features and function of the present invention, the detailed descriptions of the preferred embodiments are followed by the brief descriptions of the drawings below.

### BRIEF DESCRIPTION OF THE DRAWINGS

FIG. 1 is a flowchart of an construction method of external links for software execution environment according to the invention;

FIG. 2-a is an Installing function flow of the software execution environment according to the invention;

FIG. 2-b is an Uninstalling function flow of the software execution environment according to the invention;

FIG. 2-c is a Linking function flow of the software execution environment according to the invention;

FIG. 2-d is a Cutting function flow of the software execution environment according to the invention;

FIG. 3-a is an Enforce Output Function flow of the Object according to the invention;

FIG. 3-b is an Enforce Input Function flow of the Object according to the invention;

FIG. 3-c is an Excite Function flow of the Object according to the invention.

### DETAILED DESCRIPTION OF THE PREFERRED EMBODYMENTS

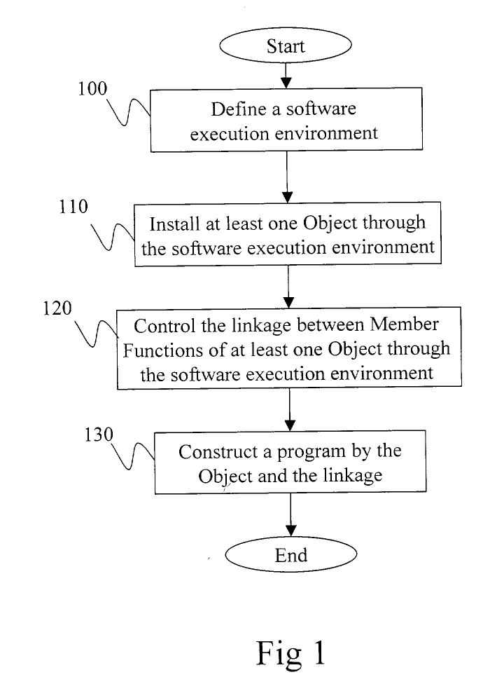

With reference to FIG. 1, the construction method of external links for software execution environment of the invention is described as follows:

First, the invention defines a software execution environment (Step 100), installs at least one Object through the software execution environment (Step 110), and then, controls the linkage of at least one Object Member Functions through the software execution environment (Step 120), at last, constructs programs by the Object and the linkage thereof (Step 130), to end up the flow herein. The software execution environment aims at reducing the complexity of the software amendment of the installation function of the Object and the Linking function of the Control Member Function.

This aforementioned Software Execution Environment uses Objects as execution units. An Object means a software structure that comprises some Member Variables and some Members Functions, just as the same definition as an Object defined in the Object Oriented Programming. This Software Execution Environment includes. some chips and/or some programming languages with specific instructions, some operating system with specific services, or some library with specific functions. In addition it further comprises the following functions: Installing, Uninstalling, Linking, Cutting and Controlling functions. The details are depicted as follows.

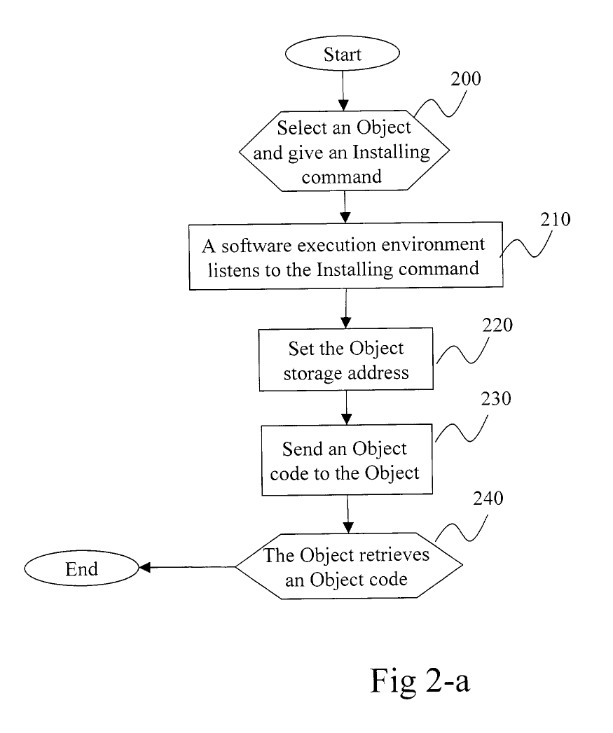

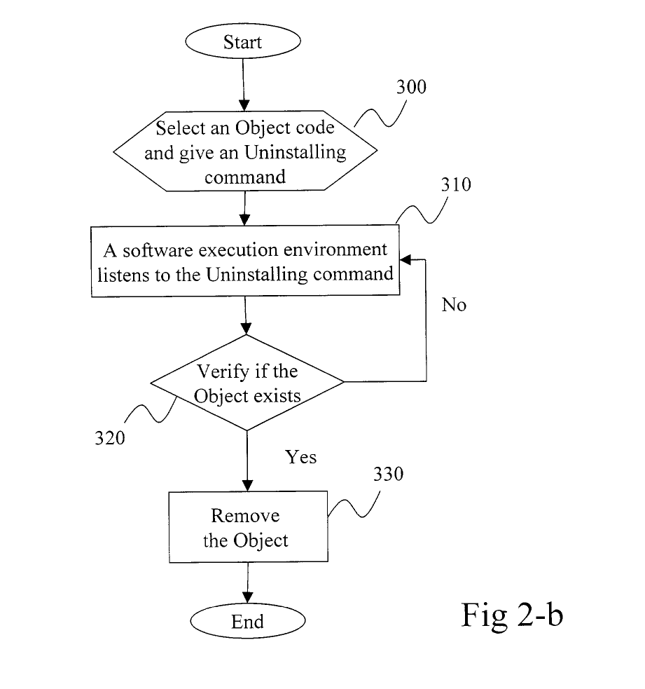

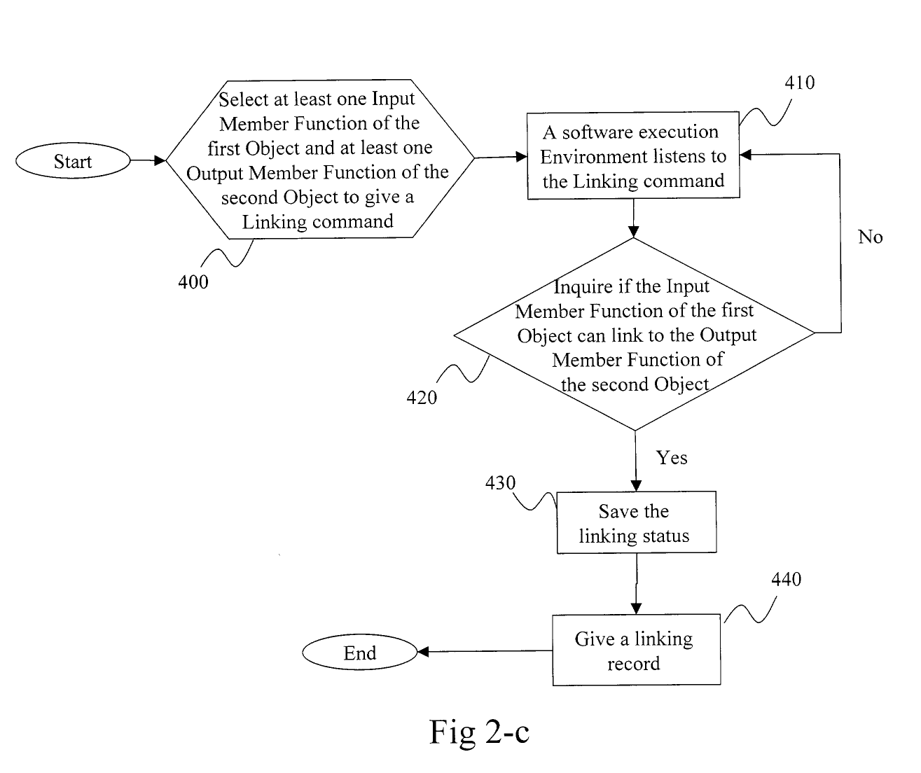

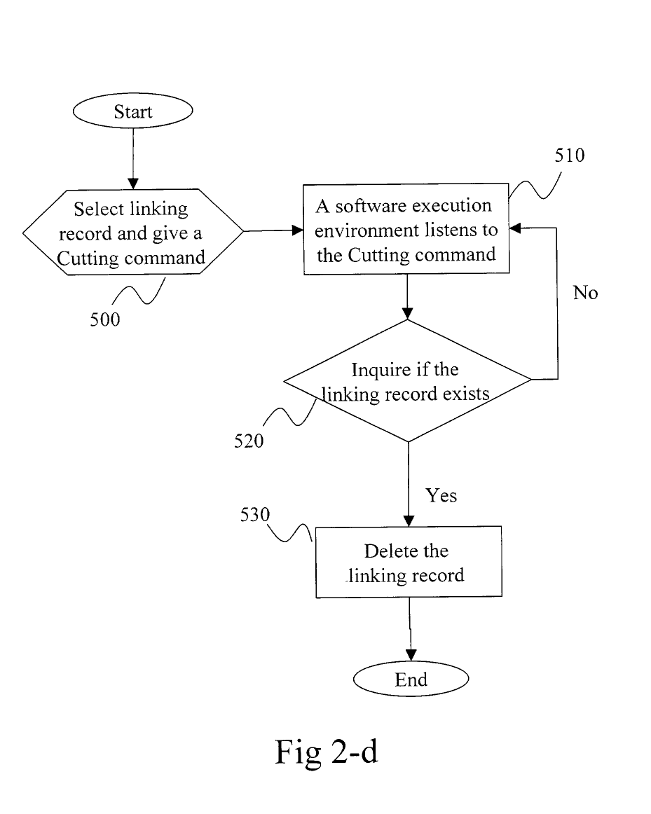

The aforementioned the Installing function is to install the Object into the software execution environment for execution. FIGS. 2-a is the Installing function flow of the software execution environment according to the invention.

First of all, the flow selects an Object and gives an Installing command(Step 200), and then listens to the Installing command through a software execution environment(Step 210), to set the storage address of the Object(Step 220), sequentially, sends out an Object code to the Object(Step 230), the flow ends up when the Object gets an Object code(Step 240).

The aforementioned Uninstalling function is to take the Object off the software execution environment and stop the execution. With reference to FIG. 2-b, it shows the Uninstalling function flow of the software execution environment according to the invention.

The flow firstly selects an Object code and gives an Uninstalling command (Step 300), and then a software execution environment listens to the Uninstalling command (Step 310), to verify if the Object exists(Step 320); if NO, the flow goes back to Step 310; otherwise, the Object is directly removed(Step 330). The flow then ends up.

The aforementioned Linking function is to link at least two Objects' Input Member Function and Output Member Function together. With reference to FIG. 2-c, it shows the Linking function flow of the software execution environment according to the invention.

The flow firstly selects at least one Input Member Function of the first Object and at least one Output Member Function of the second Object to give a Linking command(Step 400), and a software execution environment listens to the Linking command(Step 410), sequentially, inquires if the Input Member Function of the first Object and the Output Member Function of the second Object can link to each other(Step 420); if NO, the flow goes back to Step 410; otherwise, the flow stores the Linking status(Step 430), and at last, gives a linking record(Step 440). The flow then ends up.

The aforementioned Linking function can be selected from either one of the combinations of 1 to 1, 1 to n, or m to n. Besides, the Linking function can be executed among a plurality of software execution environment.

The aforementioned Cutting function is to cut a linkage. FIG. 2-d is the Cutting function flow of the software execution environment according to the invention.

First, the flow selects a linking record and gives a Cutting command(Step 500), and a software execution environment listens to the Cutting command(Step 510), and inquires if the linking record exists(Step 520); if NO, the flow goes back to Step 510; otherwise, removes the linking record(Step 530). The flow then ends up herein.

The aforementioned Controlling function is to call an Object's Control Member Function for accessing or changing the data of the Object.

Nevertheless, the aforementioned Member Functions comprise the Output Member Function, the Input Member Function and Control Member Functions. In addition, the Output Member Function comprises a type(i) Output Member Function, which does not require any parameter, but simply send out the Object status.

A type(ii) Output Member Function accepts a specific parameter and simply sends out the Object status; the specific parameter is used by the software execution environment for informing the type(ii) Output Member Function of the linking object.

In addition, the Input Member Function comprises the type(i) Input Member Function, which accepts a parameter without sending out any data, but simply deliver data from the Output Member Functions of the other Object to the Object thereof.

A type(ii) Input Member Function accepts two parameters without sending any data. The first parameter simply delivers the data of the Output Member Function of the other Object into its own Object; where the second parameter is used by the software execution environment for informing the Input Member Function of the linking object.

The Control Member Function mainly aims at enabling the Object to accept the operation from direct command.

Excepting for normal calculation and Function Invocation abilities, the Object (including its own Member Functions), with the execution environment supporting, comprises the following three Functions: Enforce Output Function, Enforce Input Function and Excite Function.

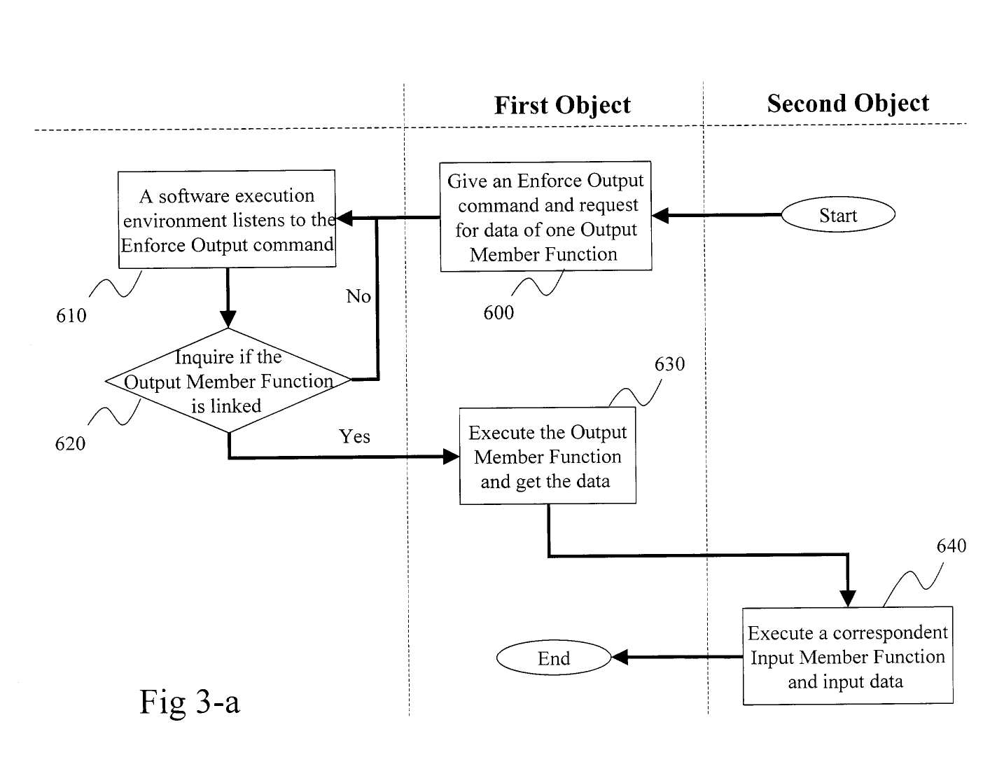

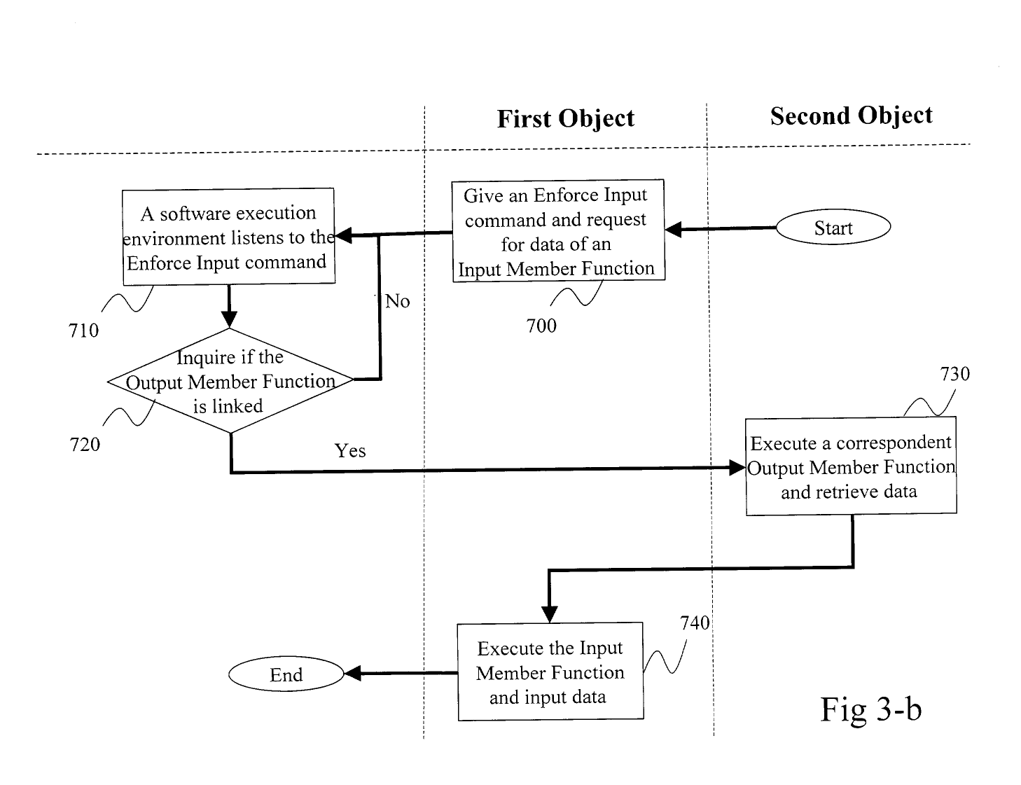

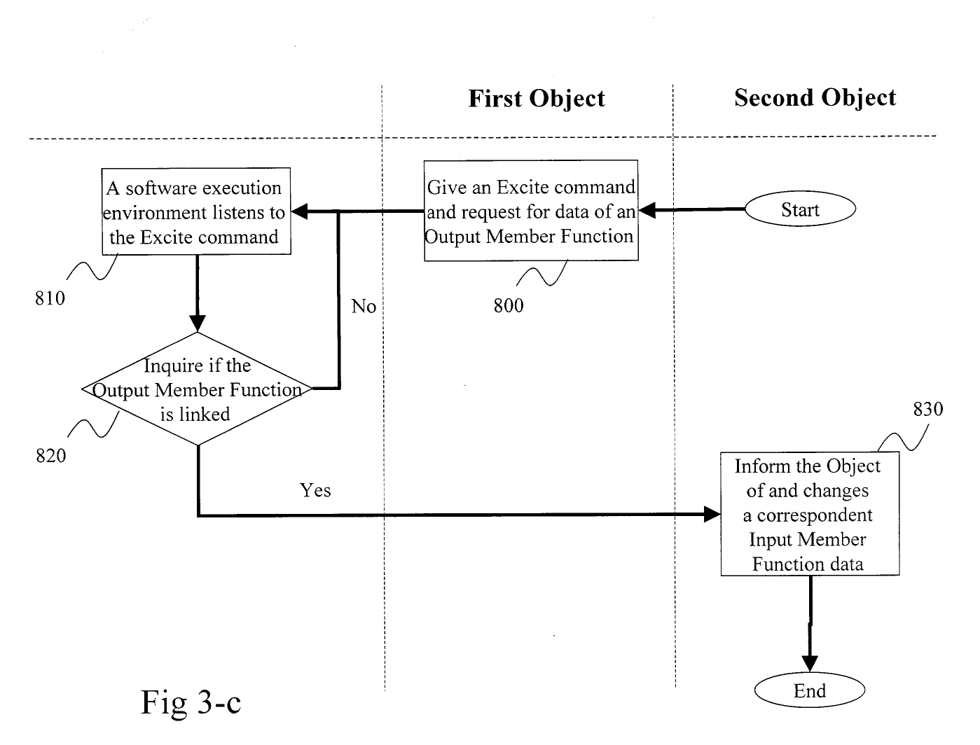

The aforementioned Enforce Output Function means that the Object requests the software execution environment for sending data from its Output Member Function to the Input Member Function. If the Output Member Function links to another Input Member Function, the software execution environment then retrieves data from the Output Member Function to be put into the parameter of the Input Member Function. If the linked Member Function is the aforementioned either type(ii) Output Member Function or the type(ii) Input Member Function, the software execution environment then informs of the other side identifier of the Linkage. FIG. 3-a is the Enforce Output Function flow of the Object according to the invention.

As shown on the drawing, first of all, the first Object gives an Enforce Output command and requests for an Output Member Function(Step 600), then a software execution environment listens to the Enforce Output command(Step 610), and inquires if the Output Member Function is linked(Step 620); if NO, the flow goes back to Step 610; otherwise, the second Object executes the Output Member Function and retrieves data(Step 630), finally, the second Object executes a correspondent Input Member Function and input data(Step 640). The flow then ends up.

The aforementioned Enforce Input Function means that the Object requests the software execution environment for retrieving a specific Input Member Function from the Object. If the Input Member Function links with another Output Member Function, the software execution environment then retrieves data from the Output Member Function to be put into the parameter of the Input Member Function. If the linked Member Function is the aforementioned type(ii) Output Member Function or the type(ii) Input Member Function, the software execution environment then informs of the other side identifier of the Linkage. FIG. 3-b is the Enforce Input Function flow of the Object according to the invention.

As shown on the drawing, the first Object gives an Enforce Input command and requests for an Input Member Function data(Step 700), then a software execution environment listens to the Enforce Input command(Step 710), and inquires if the Output Member Function is linked(Step 720); if NO, the flow goes back to Step 710; otherwise, the second Object starts to execute a correspondent Output Member Function and retrieve data(Step 730), at last, the first Object executes the Input Member Function and inputs data(Step 740). The flow ends up herein.

The aforementioned Excite Function means that when the Object data changes, the Object can request the software execution environment to Excite the linkage, which is generated by specific Output Member Function, according to the status, to enable the linking object to alert of the data change. If the linking Member Function is the aforementioned the type(ii) Output Member Function or the type(ii) Input Member Function, the execution environment, in the meanwhile, also informs the linking object. With reference to FIG. 3-c it shows the Excite Function flow of the Object according to the invention.

As shown on the drawing, the first Object gives an Excite command and requests for the data of an Output Member Function (Step 800), a software execution environment then listens to the Excite command(Step 810), and inquires if the Output Member Functions is linked(Step 820); if NO, the flow goes back to Step 810; otherwise, the second Object informs the Object of and changes the correspondent Input Member Function data (Step 830). The flow then ends up herein.

In view of the foregoing, the invention discloses an construction method of external links for software execution environment, which aims at improving the aforementioned drawbacks, e.g., an Object is only required to link its own Member Functions to enable the communication with other Objects by Execution Environment during Coding Time; in addition, the Nested Structure problem, which had been generated by the linkage requirements in the past. Therefore, this method of the invention can reduce Nested Structures by the purpose of linkage to lower software development cost and promote the flexibility of software maintenance.

To depict the effect of the invention, a specific Server is used as an embodiment herein. This Server has network communication ability.

1. This Server can be controlled by users, who can directly operate the Server, or log on from the network.

2. This Server has four abilities below:

A. Installing: Use “Server→Install(Object)” command to install an Object. A User can directly write and execute an Object program on the Server, or upload the Object program from the network for further execution.

B. Uninstalling: Use “Server→Uninstalling(Object)” command to uninstall an Object. A User can remove the Object from Server to stop the execution.

C. Linking: Use “Server→Link(the Input Member Function of the Object A and the Output Member Function of the Object B) command to build a linkage. The Server will build a linkage between the Object A's Input Member Function and the Object B's Output Member Function. If both Object A and Object B are not on the same Server, the job will be administrated by the Server's communication protocol.

D. Cutting: Use “Server→Cut(the Input Member Function of the Object A and the Output Member Function of the Object B) command to cut the linkage. The Server will cut a linkage between the Object A's Input Member Function and the Object B's Output Member Function. If both Object A and Object B are not on the same Server, the job will be done by the Server's communication protocol.

E. Controlling: Use “Server→Control(the Control Member Function of the Object A, parameters . . . )” command to control an Object. The Server will invoke the Control Member Function with given parameters, and get the returned value from this invocation.

3. Objects that are installed in the Server, can request the Server to enable the following three abilities below,

A. Enforce Output: Use “Server→Output(the Output Member Function of the Object)” command to transfer the data from the Object thereof to the Object that is on the other side of the linkage. If this linkage is across many Servers, the job will be administrated by the Server's communication protocol.

B. Enforce Input: Use “Server→Input(the Input Member Function of the Object)” command to retrieve and transfer the data from the Object that is on the other side of the linkage to this Object. If this linkage is across many Servers, the job will be administrated by the Server's communication protocol.

C. Excite: Use “Server→Excite(the Output Member Function of the Object)” command to notify the Object on the other side of the linkage that outputted data of the Output Member Function of the Object changes. If this linkage is across many Servers, the job will be administrated by the Server's communication protocol.

4. two samples of the Object designs and operations are further depicted as follows,

A. Button Object :

// Member Variable
Color C;
// Control Member Function
void Press(Color cin) {

C = cin;
Server→Output(OutputColor);

}
// Output Member Function
Color OutputColor( ) {

return C;

}

B. LightBulbObject :

// Member Variable
Color L;
// Input Member Function
void InputColor(Color lin) {

L = lin;
DisplayTheColor;

}

C. Then we can use the following commands, to install these two Objects into Server, and call the ButtonObject's Press Member Function, then the LightBulbObject will show the color:

a. Server→Install (ButtonObject)

b. Server→Install (LightBulbObject)

c. Server→Link (LightBulbObject.InputColor, ButtonObject.OutputColor)

d. Server→Control (ButtonObject.Press, Green)

e. Then the LightBulbObject will show the green color.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A construction method of external links for software execution environment, being a specific software structure which focuses on the redefinition to the linkage between Objects, comprising the following Steps:
defining a software execution environment;
installing at least one Object through the software execution environment;
controlling the linkage between at least one Object Member Function through the software execution environment;
constructing a program by the Object and the linkage; and
reducing the complexity of amending software by the said software execution environment, which focuses on the functions of installing the Object and Controlling the linkage of the Member Functions.

2. The construction method of external links for software execution environment of claim 1, wherein the software execution environment includes some chips and programming languages with specific instructions, operating systems with specific services or library with specific functions, further comprising: an Installing function, an Uninstalling function, a Linking function, a Cutting function and a Controlling function.

3. The construction method of external links for software execution environment of claim 2, wherein the Installing function is to install the Object into the software execution environment for execution; it comprising the following Steps:
selecting the Object and giving an Installing command;
listening to the Installing command by the software execution environment;
setting a storage address of the Object;
sending an Object code to the Object;
retrieving an Object code by the Object.

4. The construction method of external links for software execution environment of claim 2, wherein the Uninstalling function is to take the Object off the execution environment and stop the execution; it comprising the following Steps:
selecting an Object code and giving an Uninstalling command;
listening to the Uninstalling command by the software execution environment;
verifying if the Object exists;
deleting the Object.

5. The construction method of external links for software execution environment of claim 2, wherein the Linking function is to link with an Input Member Function and an Output Member Function of at least two Objects forming a linkage; it comprising the following Steps:
selecting at least one Input Member Function of the first Object and at least one Output Member Function of the second Object and giving a Linking command;
listening to the Linking command by the software execution environment;
inquiring if the Input Member Function of the first Object can link to the Output Member Function of the second Object;
saving the linkage; and
giving a linking record.

6. The construction method of external links for software execution environment of claim 5, wherein the Linking function can be chosen from one of the combination of 1 to 1, 1 to n, or m to n.

7. The construction method of external links for software execution environment of claim 5, wherein the Linking function can operate among a plurality of software execution environments.

8. The construction method of external links for software execution environment of claim 2, wherein the Cutting function is to cut a linkage; it comprising the following Steps:
Selecting a linking record and giving a Cutting command;
listening to the Cutting command by the software execution environment;
inquiring if the linking record exists;
removing the linking record.

9. The construction method of external links for software execution environment of claim 2, wherein the Controlling function is to call a Control Member Function of the Object and control the internal data of the Object.

10. The construction method of external links for software execution environment of claim 1, wherein the Object Member Function further comprises an Output Member Function, an Input Member Function and a Control Member Function.

11. The construction method of external links for software execution environment of claim 10, wherein the Output Member Functions further comprises:
A type(i) Output Member Function, which dose not require any parameter, but simply send out the Object status;
A type(ii) Output Member Function, which accepts a specific parameter, and simply send out the Object status.

12. The construction method of external links for software execution environment of claim 11, wherein the specific parameter is used by the software execution environment for informing the type(ii) Output Member Function of a linking object.

13. The construction method of external links for software execution environment of claim 10, wherein the Input Member Function further comprises:
A type(i) Input Member Function accepts a parameter without sending out any data but simply delivers the Output Member Function of the Object into its own Object;
a type(ii) Input Member Function accepts two parameters without sending out any data. The first parameter simply delivers the Output Member Function of the other Object into its own Object; where the second parameter is used by the software execution environment for informing of the Input Member Function of a linking object.

14. The construction method of external links for software execution environment of claim 10, wherein the Control Member Function mainly enables the Object to directly accept command for operation.

15. The construction method of external links for software execution environment of claim 1, wherein the Object further comprises the following functions: an Enforce Output Function, an Enforce Input Function and an Excite Function.

16. The construction method of external links for software execution environment of claim 15, wherein the Enforce Output Function means that the Object requests the software execution environment for sending out data from a specific Output Member Function of the Object; it comprising the following Steps:
giving an Enforce Output command and requesting for data of an Output Member Function;
listening to the Enforce Output command by the software execution environment;
inquiring if the Output Member Function exists;
executing the Output Member Function and retrieving data; and
executing a correspondent Input Member Function and inputting data.

17. The construction method of external links for software execution environment of claim 15, wherein the Enforce Input Function means that the Object requests the software execution environment for inputting data from a specific Input Member Function of the Object; it comprising the following Steps:
Giving an Enforce Input command and asking for data of an Input Member Function;
listening to the Enforce Input command by the software execution environment;
inquiring if the Output Member Function exists;
executing a correspondent Output Member Function and retrieving data; and
executing the Input Member Function and inputting data.

18. The construction method of external links for software execution environment of claim 15, wherein the Excite Function means that data of the Object changes, therefore, the Object asks the software execution environment for Exciting a linkage formed by specific Output Member Functions to enable the linking object to find the data change; it comprising the following Steps:
giving an Excite command and asking for data of an Output Member Function;
listening to the Excite command by the software execution environment;
inquiring if the Output Member Function exists; and
informing the Object of and changing the correspondent data of the Input Member Function.
